(19) United States
(12) Patent Application Publication
(10) Pub. No.: US 2015/0047143 A1
(43) Pub. Date: Feb. 19, 2015

(54) WIPER ARM APPARATUS FOR PREVENTING PAINTED LAYER CRACK

(71) Applicant: DONGYANG MECHATRONICS CORP., Incheon (KR)

(72) Inventor: Jae Ho Lee, Incheon (KR)

(73) Assignee: DONGYANG MECHATRONICS CORP., Incheon (KR)

(21) Appl. No.: 14/325,025

(22) Filed: Jul. 7, 2014

(30) Foreign Application Priority Data
Aug. 13, 2013 (KR) 10-2013-0096064

(51) Int. Cl. B60S 1/34

(52) U.S. Cl. CPC B60S 1/3459; B60S 1/3425
USPC 15/250.352

(57) ABSTRACT

A wiper arm apparatus for preventing painted layer crack includes an arm head; a retainer coupled to one end of the arm head and provided rotatable relative to the arm head; and a rivet constituting a rotation axis by being disposed so as to penetrate through a coupling portion of the retainer and the arm head. The rivet includes a bearing unit slidingly contacting an inner circumferential surface of a through hole formed in the arm head, a head unit supported in contact with one side of the retainer, and a caulking unit fixed to the other side of the retainer with the bearing unit interposed where-between. The rivet further includes a vibration preventing unit that is disposed between the head unit and the retainer, and forcibly inserted into an assembly hole formed in the retainer.

### CROSS REFERENCE TO RELATED APPLICATIONS

This application claims the benefit of Korean Patent Application No. 10-2013-0096064, filed on Aug. 13, 2013, in the Korean Intellectual Property Office, the disclosure of which is incorporated herein in its entirety by reference.

### BACKGROUND

1. Field

One or more embodiments of the present invention relate to a wiper arm apparatus for vehicles.

2. Description of the Related Art

In general, a vehicle includes a wiper arm apparatus for removing foreign matters or rainwater from a windshield or a rear window of the vehicle to secure driver's sight. The wiper arm apparatus is a convenience device for vehicles and, at the same time, an active safety device.

The wiper arm apparatus is reciprocally rotated by a wiper motor provided in the vehicle. The wiper arm apparatus includes an arm head fixed to a pivot shaft which is reciprocally rotated by the wiper motor, a retainer which is coupled to the arm head and is provided to be rotated in a certain angle range with respect to the arm head, and a blade which is coupled to an end of the retainer.

According to this structure, the arm head and the retainer form an articulation structure. The arm head and the retainer are generally rotatably coupled to each other by a rivet. The retainer and the arm head are provided so that an elasticity restoration force is applied to the retainer in a direction where the retainer is pressed on the glass of the vehicle by a spring.

An example of such a wiper arm apparatus is disclosed in Japanese Patent publication No. 2012-206610.

FIG. 1 illustrates a coupling unit of an arm head 2 and a retainer 3 of a conventional wiper arm apparatus. FIG. 2 is a sectional view taken along line II-II illustrated in FIG. 1. FIG. 3 is a sectional view for describing a cause of cracking of a painted layer 6 in the structure illustrated in FIG. 2.

Referring to FIGS. 1 through 3, the arm head 2 and the retainer 3 are rotatably coupled to each other by a rivet 4. However, after the arm head 2 and the retainer 3 are coupled by the rivet 4, the surface of the retainer 3 is painted. An assembly hole 5 formed in the retainer 3 is typically processed to have a circumference different from the outer circumference of the rivet 4 by a gap of about 0.05 to about 0.2 mm, in consideration of the assembly of the rivet 4

A gap between the rivet 4 connected to the assembly hole 5 and the retainer 3 in consideration of the assembly tolerance may cause a vibration between the retainer 3 and the rivet 4 to occur due to repeated use of the wiper arm apparatus. When there is a gap between the retainer 3 and the rivet 4, the rivet 4 repeatedly vibrates with respect to the retainer 3. As a result, the painted layer 6 may be cracked at a contact point between the head of the rivet 4 and the retainer 3. When the painted layer 6 is cracked, the surface of the retainer 3 may be eroded, and thus the life of components of the wiper arm apparatus may be shortened.

### SUMMARY

One or more embodiments of the present invention include a wiper arm apparatus for preventing a painted layer crack by having an improved structure in which a vibration between a retainer and a rivet of the wiper arm apparatus does not occur.

Additional aspects will be set forth in part in the description which follows and, in part, will be apparent from the description, or may be learned by practice of the presented embodiments.

According to one or more embodiments of the present invention, a wiper arm apparatus for preventing painted layer crack includes an arm head, a retainer coupled to one of the arm head and provided to be rotatable relative to the arm head, and a rivet constituting an rotation axis by being disposed so as to penetrate through coupling portion of the retainer and the arm head. The rivet includes a bearing unit slidingly contacting an inner circumferential surface of a through hole formed in the arm head, a head unit contacting one side of the retainer and supported by the one side of the retainer, and a caulking unit fixed to the other side of the retainer with the bearing unit interposed there-between. The rivet further includes a vibration prevention unit that is disposed between the head unit and bearing unit and that is forcibly inserted into an assembly hole formed in the retainer.

The vibration preventing unit may have a structure in which repeated irregularities are formed along an outer circumferential surface of the rivet.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view showing a coupling unit of an arm head and a retainer of a conventional wiper arm apparatus;

FIG. 2 is a sectional view taken along line II-II illustrated in FIG. 1;

FIG. 3 is a sectional view for describing a cause of a painted layer crack in the conventional wiper arm apparatus illustrated in FIG. 2;

FIG. 4 is a sectional view for describing a structure of a wiper arm apparatus according to an exemplary embodiment of the present invention; and

FIG. 5 is a perspective view three-dimensionally showing a structure of a rivet included in the wiper arm apparatus illustrated in FIG. 4

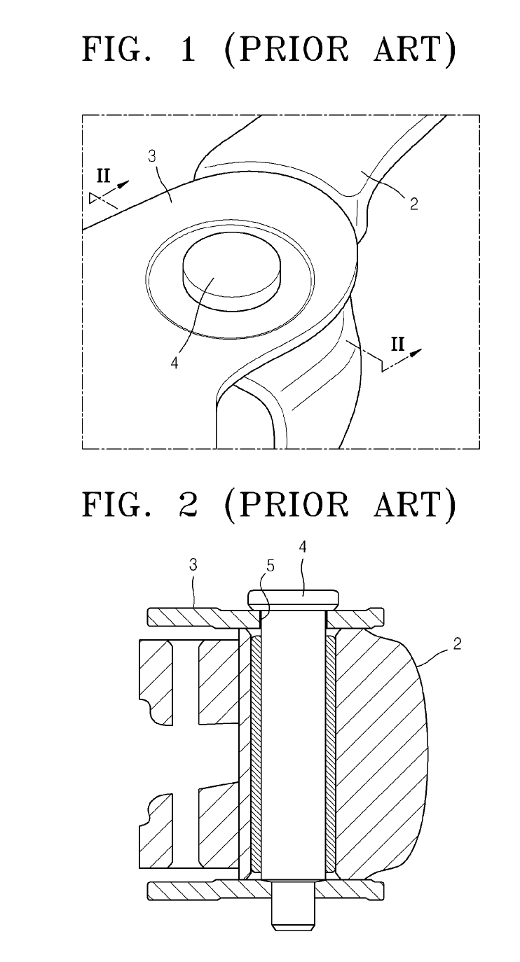

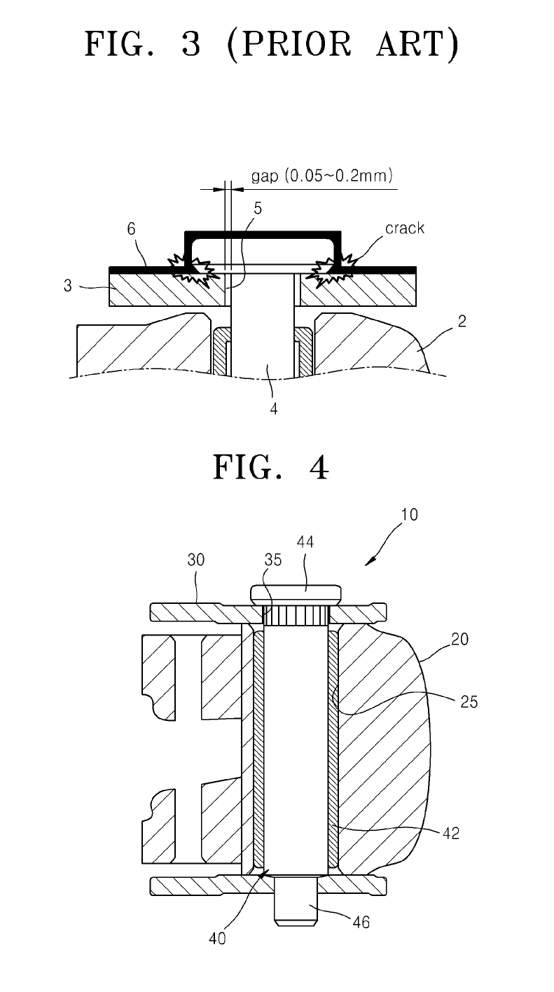

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

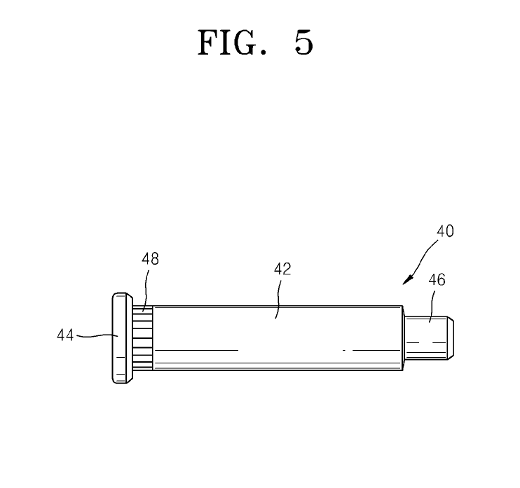

FIG. 4 is a sectional view for describing a structure of a wiper arm apparatus 10 preventing a painted layer crack, according to an exemplary embodiment of the present invention. FIG. 5 is a perspective view three-dimensionally showing a structure of a rivet 40 illustrated in FIG. 4.

With reference to FIGS. 4 and 5, the wiper arm apparatus 10 preventing a painted layer crack (hereinafter, referred to as the wiper arm apparatus 10) includes an arm head 20, a retainer 30, and the rivet 40.

The arm head 20 is fixed to a pivot shaft (not shown) provided in a vehicle. The pivot shaft reciprocally rotated by a wiper motor. The arm head 20 reciprocally rotates together with the pivot shaft when the pivot shaft reciprocally rotates.

The arm head 20 includes a through hole 25 as illustrated FIG. 4, which is a structure used to couple the arm head 20 to the retainer 30 which will be described later.

The retainer 30 is coupled to one end of the arm head 20. The retainer 30 is provided to be rotated with respect to the arm head 20. In other words, the retainer 30 is coupled with the arm head 20 to form an articulation structure. The retainer 30 and the arm head 20 are rotatably coupled with each other by using the rivet 40 which will be described later. The retainer 30 includes an assembly hole 35 in order to be coupled with the arm head 20 via the rivet 40, as illustrated FIG. 4.

The rivet 40 is disposed so as to penetrate coupling portions of the retainer 30 and the arm head 20. In more detail, the rivet 40 is disposed to penetrate the assembly hole 35 and the through hole 25. The rivet 40 forms a rotation axis when the arm head 20 and the retainer 30 are combined with each other in an articulation structure. The rivet 40 includes a bearing unit 42, a head unit 44, a caulking unit 46, and a vibration preventing unit 48.

The bearing unit 42 forms a column. The outer circumferential surface of the bearing unit 42 is disposed to slidingly contact the inner circumferential surface of the through hole 25 formed in the arm head 20. The bearing unit 42 may be formed of a material with a low friction coefficient. The bearing unit 42 may be previously assembled into the through hole 25 formed in the arm head 20.

The head unit 44 contacts one side of the retainer 30 and is supported by the one side of the retainer 30. The head unit 44 has a larger outer diameter than the bearing unit 42 so that the rivet 40 does not escape from the retainer 30 through the assembly hole 35.

The caulking unit 46 is disposed on a side of the bearing unit 42 opposite to the head unit 44. The caulking unit 46 is fixed to the other side of the retainer 30 by being plastically deformed by a caulking process.

The vibration preventing unit 48 is a component that plays a key role in the present invention.

The vibration preventing unit 48 is disposed between the head unit 44 and the bearing unit 42. The vibration preventing unit 48 is forcibly inserted into the assembly hole 35 formed in the retainer 30 so that a gap between the rivet 40 and the assembly hole 35 is not formed. In more detail, the vibration preventing unit 48 has a serration structure in which irregularities are repeatedly formed along the outer circumference of the rivet 40. When the vibration preventing unit 48 is forcibly inserted into the assembly hole 35 formed in the retainer 30, the vibration preventing unit 48 is slightly plastically deformed. At this time, spaces due to the irregularities may be filled with the material of the vibration preventing unit 48 due to the plastic deformation.

Effects of the wiper arm apparatus 10 including the above-described components will now be explained in detail by illustrating an assembling process and a working process of the wiper arm apparatus 10.

First, in the process of coupling the arm head 20 with the retainer 30, the arm head 20 and the retainer 30 are disposed so that the through hole 25 of the arm head 20 and the assembly hole 35 of the retainer 30 are coaxially disposed. In this state, the rivet 40 is coupled such that the caulking unit 46 of the rivet 40 penetrates through the assembly hole 35, the through hole 25, and a hole formed in the other side of the retainer 30. The vibration preventing unit 48 formed in the rivet 40 is forcibly fitted into the assembly hole 35. Therefore, the rivet 40 is fixed to the retainer 30 without having a gap therebetween. Then, the caulking unit 46 is plastically deformed by an outer force applied by a tool such as a hammer. The caulking unit 46 has a shape similar to the head unit 44 due to the plastic deformation, and thus the rivet 40 is prevented from being escaped from the retainer 30. The retainer 30 and the arm head 20 are mounted so that the retainer 30 is pressed against the glass side of a vehicle by a spring (not shown).

A blade (not shown) is coupled to one end of the wiper arm apparatus 10 assembled in this way, and the other end of the wiper arm apparatus 10 is assembled to the pivot shaft. A resultant structure is mounted in the vehicle.

The wiper arm apparatus 10 mounted in the vehicle executes its function by repeatedly and reciprocally rotating. The wiper arm apparatus 10 may be switched to a lock back state in which the retainer 30 is rotated at a certain angle with respect to the arm head 20, in order to replace the blade assembled to the wiper arm apparatus 10 with a new one. In this process, relative rotation of the retainer 30 in relation to the arm head 20 frequently occurs. However, since no gaps are formed between the retainer 30 and the rivet 40 by the vibration preventing unit 48, the rivet 40 and the retainer 30 integrally move without relatively vibrating. In particular, if the vibration preventing unit 48 has an uneven structure as in the exemplary embodiment of the present invention, even when the vibration preventing unit 48 is plastically deformed when being forcibly inserted into the assembly hole 35, concave spaces of the uneven structure are filled with the material of the vibration prevention unit 48. This suppresses damage to the assembly hole 35. Therefore, a painted layer around a contact area of the head unit 44 and the retainer 30 does not crack.

In the wiper arm apparatus 10 according to the above-described embodiment of the present invention, the vibration preventing unit 48 is disposed between the head unit 44 and the bearing unit 42 and is forcibly inserted into the assembly hole 35 formed in the retainer 30, thereby preventing any vibration from occurring between the rivet 40 and the retainer 30 coupled to each other. Consequently, a painted layer on the surfaces of components is prevented from being destroyed, and thus the durability of the wiper arm apparatus 10 increases.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claim.

What is claimed is:

1. A wiper arm apparatus for preventing painted layer crack, the wiper arm apparatus comprising:
an arm head;
a retainer coupled to one end of the arm head and provided to be rotatable relative to the arm head; and
a rivet constituting a rotation axis by being disposed so as to penetrate through coupling portions of the retainer and the arm head,
wherein the rivet comprises a bearing unit slidingly contacting an inner circumferential surface of a through hole formed in the arm head, a head unit contacting one side of the retainer and supported by the one side of the retainer, and a caulking unit fixed to the other side of the retainer with the bearing unit interposed therebetween, and
the rivet further comprises a vibration prevention unit that is disposed between the head unit and the bearing unit and that is forcibly inserted into an assembly hole formed in the retainer.

2. The wiper arm apparatus of claim 1, wherein the vibration preventing unit has a structure in which repeated irregularities are formed along an outer circumferential surface of the rivet.
